(19) United States
(12) Patent Application Publication
(10) Pub. No.: US 2008/0049712 A1
(43) Pub. Date: Feb. 28, 2008

(54) Radio apparatus, radio communication system, and radio communication method

(75) Inventors: Shigeo Terabe, Kawasaki-shi (JP); Kengo Kurose, Hamura-shi (JP); Yutaka Asanuma, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/700,499

(22) Filed: Jan. 31, 2007

(30) Foreign Application Priority Data
Aug. 25, 2006 (JP) 2006-229255

(51) Int. Cl. H04B 7/212

(52) U.S. Cl. 370/348

(57) ABSTRACT

A mobile station measures channel variation in a time direction and channel variation in a frequency direction, and selects a CQI compression method to be actually applied, on the basis of a CQI updating cycle, a CQI channel size, the channel variation in the time direction and the channel variation in the frequency direction transmitted from a base station. The mobile station notifies the base station of CQI format information associated with the selected CQI compression method together with a measured CQI value. On the basis of the CQI format information, the base station analyzes in what compression method the CQI value is compressed, and executes scheduling in accordance with a result of the analysis.

### CROSS-REFERENCE TO RELATED APPLICATIONS

This application is based upon and claims the benefit of priority from prior Japanese Patent Application No. 2006-229255, filed Aug. 25, 2006, the entire contents of which are incorporated herein by reference.

### BACKGROUND OF THE INVENTION

1. Field of the Invention

The present invention relates to a radio communication system capable of executing adaptive control of the modulation scheme and the error-correcting-coding rate, for example, on the basis of CQI (Channel Quality Indication).

2. Description of the Related Art

In a conventional system employing the adaptive modulation, the mobile station measures radio channel quality of a base station having a most desirable receiving signal quality, and transmits the channel quality information to the base station, and the base station determines a transmission format (i.e. combination of the modulation and the coding rate) which can be received by the mobile station, on the basis of the value of the channel quality information or the mobile station determines a receivable transmission format (i.e. combination of the modulation and the coding rate) on the basis of the value of the channel quality, and transmits the transmission format information to the base station. At this time, feedback information which is transmitted to the base station is called CQI (Channel Quality Indication).

On the basis of the transmission format, the base station transmits control information over an dedicated control information channel, by choosing the appropriate modulation scheme of the data to be transmitted to the mobile station. In other words, when the receiving condition of the mobile station is preferable, the base station executes the transmission at a high-speed data transmission rate having a low error tolerance. When the radio condition is poor, the base station executes the transmission at a low-speed data transmission rate having a high error tolerance.

The data transmissions are thus made at various communication rates corresponding to the downlink receiving signal quality, but the determination of the downlink receiving signal quality is based on a table prestored in the mobile station (or the base station). This table directly represents a predicted downlink data transmission speed, which is a very correct data transmission speed obtained by considering the correction using statistic data such as the error rates of predicted and previous downlink data transmissions.

The radio system which implements high-speed data transmission by executing such adaptive modulation is generally in a best-effort type service form. For this reason, the mobile station requires the only base station of the most desirable receiving signal quality to make communications. The base station transmits packets, with priority, to the mobile station which requires the high transmission rate of preferable downlink receiving signal quality (Maximum CIR).

For this reason, the priority in making communications with the base station is low for a mobile station which does not have preferable downlink receiving signal quality. As a method of solving this and increasing both the user throughput and the base station throughput in good balance, for example, PF (Proportional Fairness) scheduler method of the 1xEV-DO system is known (refer to, for example, IEEE International Conference, VTC, 2000 Spring, “Data throughput of CDMA-HDR a High Efficiency-High Data Rate Personal Communication Wireless System” written by A. Japali, R. Padovani and R. Pankaj).

The PF scheduler method employs evaluation function values calculated at “SNR_inst/SNR_ave” as an index which the base station uses for user selection. The base station calculates the evaluation functions values for the respective mobile stations and selects the mobile station which has the greatest evaluation function values. “SNR_inst” represents instantaneous SNR of which the mobile station notifies the base station. “SNR_ave” represents an average value of SNR.

In the OFDM (Orthogonal Frequency Division Multiplexing) system, communications are made by simultaneously employing a number of subcarriers. At this time, the mobile stations can be assigned to the subcarriers, respectively. The OFDM system is similar to the conventional FDM system with respect to assigning a specific frequency to each of the mobile stations. However, the OFDM system is significantly different in the point that each mobile station receives all the subcarriers of the OFDM simultaneously, executes reception of the OFDM signals, and takes the subcarrier which it should receive.

Incidentally, there are a certain cycle updating mode, a transmitting-side trigger based mode and a receiving-side trigger based mode as the CQI control method. In the certain cycle updating mode, the CQI updating timing and the CQI channel size are predetermined and the receiving side (mobile station side) executes the CQI transmission on the basis of the predetermined CQI updating timing and the CQI channel size.

In the transmitting-side trigger based mode, the transmitting side (base station side) determines the CQI updating timing and the CQI channel size with occurrence of the transmission traffic and execution of the receiver scheduling handled as triggers, and notifies the receiving side of the CQI updating timing and the CQI channel size. In the receiving-side trigger based mode, the receiving side notifies the transmitting side of the CQI updating request with environmental change of the own side as a trigger. When the transmitting side receives the CQI updating request, the transmitting side determines the CQI updating timing and the CQI channel size and notifies the receiving side of the determined CQI updating timing and CQI channel.

However, the CQI control method of the trigger mode has a problem of deterioration of the receiving performance caused together with delay of the CQI information. In other words, since the receiving signal quality of the receiving side is not monitored in the transmitting-side trigger based mode, the receiving signal quality may not be triggered at a preferable timing. Even if the receiving signal quality is triggered at a preferable timing in the receiving-side trigger based mode, the receiving signal quality may be modified due to delay of the following communication and the receiving signal quality may not become preferable. Moreover, the certain cycle updating mode has a problem of increase in the signaling overhead from the receiving side to the transmitting side, which results from the CQI channel size. In general, the problems of both the modes have a relationship of trade-off.

In other words, the trigger based mode has a problem that the delay of the CQI transmission becomes great and the receiving performance is deteriorated, since information needs to be exchanged between the receiving side and the transmitting side. However, the signaling overhead is small since the CQI is transmitted at a necessary time alone.

On the other hand, the delay to the CQI transmission is small in the certain cycle updating mode, since the CQI is transmitted at a determined CQI updating timing. For this reason, a problem of delay does not occur but the signaling overhead from the receiving side to the transmitting side is great since the CQI channel is transmitted for each certain period.

To solve this problem, a compressing method of the CQI information is proposed. As a conventional CQI information compressing method, there are a frequency-direction averaging mode, a frequency-direction Best M mode and a time-direction averaging mode. In the frequency-direction averaging mode, number N (integer equal to or more than 0) of CQI values successive in the frequency-direction are averaged and transmitted to the transmitting side. In the frequency-direction Best M mode, each of the CQI value of the M channel having a high CQI value, the bit map representing the position of the resource group and the average CQI value of the other channels is obtained and transmitted to the transmitting side. In the time-direction averaging mode, CQI values of number P (integer equal to or greater than 1) of sub-frames successive in the time-direction are averaged and the CQI is transmitted to the transmitting side in accordance with its averaging cycle.

In these CQI information compressing modes, however, the information drop may be caused together with great compression due to the channel environment and the moving speed of the receiving side, and there was not an only conventional reducing method satisfying all the conditions.

In the conventional radio communication system, the transmission quality is degraded due to great signaling overhead from the receiving side to the transmitting side resulting from the CQI channel size or the delay of the CQI information.

### BRIEF SUMMARY OF THE INVENTION

The present invention has been accomplished to solve the above-described problems. The object of the present invention is to provide a radio apparatus, a radio communication system, and a radio communication method capable of executing high-quality signal transmission by making the signaling overhead from the receiving side to the transmitting side resulting from the CQI channel size smaller and by making the delay of the CQI information smaller.

To achieve this object, an aspect of the present invention is a radio apparatus, notifying a radio station of a channel quality and executing radio communication with the radio station under adaptive control of the radio station based on the channel quality. The radio apparatus comprises first measurement means for measuring variations of a plurality of channels utilized in the communication with the radio station, second measurement means for measuring receiving qualities of a plurality of channels utilized in the communication with the radio station, compression means for generating quality information of compressing a result of the measurement of the second measurement means, in a manner corresponding to a result of the measurement of the first measurement means, and transmission means for transmitting to the radio station the quality information generated by the compression means and compression manner information representing the manner employed by the compression means.

According to the present invention, as described above, the variation and the receiving signal quality of a plurality of channels that can be employed with the partner station are measured, the quality information is generated by compressing the receiving qualities of the plural channels in the manner corresponding to the measured channel variation, and the quality information and the compressing method information are transmitted to the partner station.

Therefore, the present invention can compress the receiving qualities of the plural channels in the compressing method corresponding to the channel variation and notify the partner station of the receiving qualities, and can also transmit the employed compressing method. Thus, the present invention can provide a radio apparatus, a radio communication system, and a radio communication method capable of executing high-quality signal transmission by making the signaling overhead smaller and by making the delay of the receiving signal quality transmission smaller.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an illustration showing an example of band assignment for an dedicated control information channel of a radio communication system according to the present invention;

FIG. 2 is a block diagram showing a configuration of a receiver (mobile station) of the radio communication system according to an embodiment of the present invention;

FIG. 3 is a block diagram showing a configuration of a transmitter (base station) of the radio communication system according to the embodiment of the present invention;

FIG. 4 is an illustration describing a processing routine executed in the radio communication system according to the embodiment of the present invention;

FIG. 5 is an illustration describing an example of a CQI compressing method employed in the radio communication system according to the embodiment of the present invention;

FIG. 6 is an illustration describing another example of the CQI compressing method employed in the radio communication system according to the embodiment of the present invention;

FIG. 7 is an illustration describing still another example of the CQI compressing method employed in the radio communication system according to the embodiment of the present invention;

FIG. 8 is an illustration describing further another example of the CQI compressing method employed in the radio communication system according to the embodiment of the present invention;

FIG. 9 is an illustration describing an example of discrimination standards of selecting the CQI compressing methods shown in FIG. 5 to FIG. 8;

FIG. 10 is an illustration describing an example of a CQI channel employed in the radio communication system according to the embodiment of the present invention;

FIG. 11 is an illustration describing still further another example of the CQI compressing method employed in the radio communication system according to the embodiment of the present invention;

FIG. 12 is an illustration describing still further another example of the CQI compressing method employed in the radio communication system according to the embodiment of the present invention;

FIG. 13 is an illustration describing still further another example of the CQI compressing method employed in the radio communication system according to the embodiment of the present invention;

FIG. 14 is an illustration describing still further another example of the CQI compressing method employed in the radio communication system according to the embodiment of the present invention; and

FIG. 15 is an illustration describing an example of discrimination standards of selecting the CQI compressing methods shown in FIG. 11 to FIG. 14.

### DETAILED DESCRIPTION OF THE INVENTION

An embodiment of the present invention is described below with reference to the accompanying drawings.

The present inventors have also reviewed a system employing a plurality of CQI information compressing methods of the frequency-direction averaging mode, the frequency-direction Best M mode and the time-direction averaging mode and simply changing the plurality of modes.

In this system, however, the transmitting side and the receiving side need to determine the CQI channel at every compression and a problem concerning the receiving performance degradation caused by delay occurs, since the compressed CQI channel sizes of the compression modes are different from each other. An embodiment of a radio communication system which also solves this problem is described below. An example of a cellular system employing OFDM (orthogonal frequency division multiplexing) as the modulation scheme in a downlink in which the base station transmits signals to the base station, is cited in the descriptions.

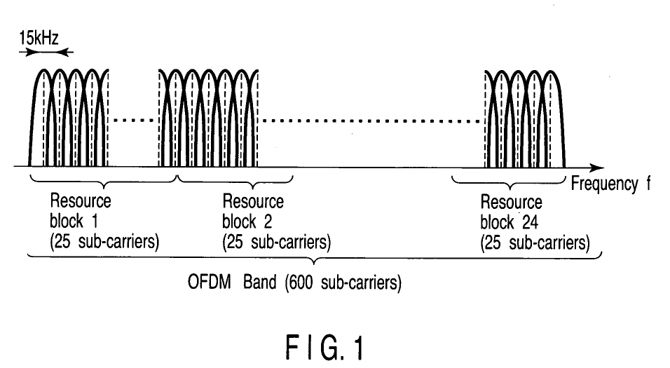

In the OFDM modulation, high-speed data signals are converted into low-speed narrow-band data signals, which are transmitted in parallel with a plurality of sub-carriers in a frequency axis. In this embodiment, the OFDM is composed of six-hundred sub-carriers with a sub-carrier distance of 15 kHz. Twenty-four bands (resource blocks) are assigned to the dedicated control information channels and each band is composed of twenty-five sub-carriers, as shown in FIG. 1.

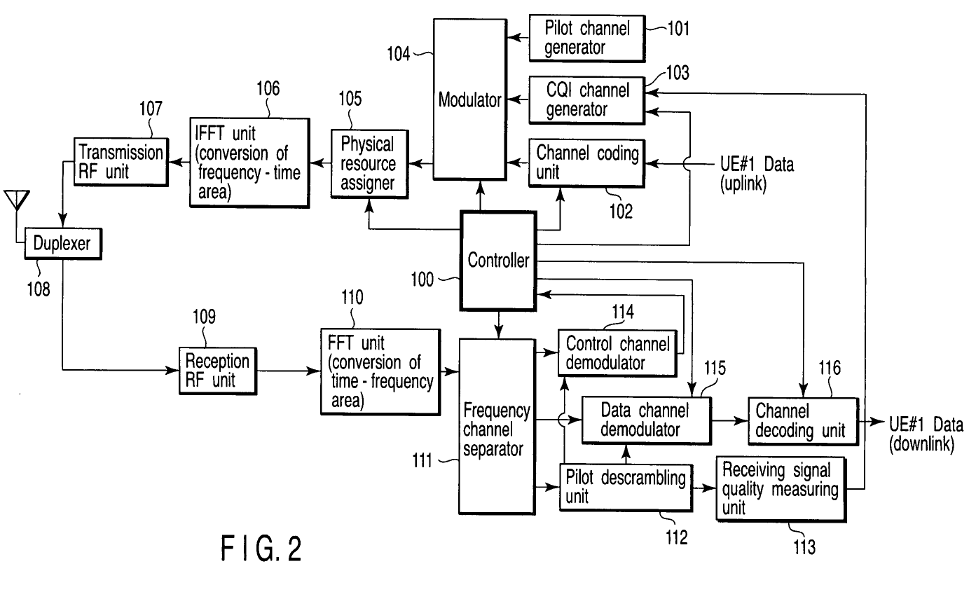

FIG. 2 shows a configuration of a receiver (mobile station) of a radio communication system according to an embodiment of the present invention.

A pilot channel generator 101 generates a bit string which is an original signal of a pilot signal to be transmitted over a pilot channel, processes the bit string with a scrambling code and outputs the bit string to a modulator 104. In accordance with an designation of a controller 100, a CQI channel generator 103 generates a bit string of CQI information to be transmitted over a CQI channel, on the basis of a channel variation amount and a measuring unit of a receiving signal quality measuring unit 113, and outputs the bit string to the modulator 104. The CQI channel generator 103 can also execute channel coding of the CQI information. A channel coding unit 102 executes channel coding of an uplink transmission data bit string at a channel coding rate designated by the controller 100 and outputs the channel codes to the modulator 104.

The modulator 104 generates a pilot signal, a CQI signal and a transmit data signal by subjecting the bit strings which are the original signals of the pilot signal, the CQI information and the channel-coded uplink transmit data signal, to digital modulation such as quadrature phase shift keying (QPSK) in a modulation scheme designated by the controller 100.

The generated pilot signal and transmit data signal are assigned to respective sub-carriers designated by the controller 100, by a physical resource assigner 105. To “assign signals to sub-carriers” means to add a sub-carrier index representing positions in a time axis and a frequency axis, of the sub-carriers in the corresponding resource block, to signals represented by complex numbers.

An inverse fast Fourier transform (IFFT) unit 106 converts a signal of the frequency area output from the physical resource assigner 105 into a signal of the time area, which is converted into a radio (RF) signal by a transmission RF unit 107 comprising a digital-analog converter, an up-converter, a power amplifier, etc. The RF signal is emitted into space, toward the base station, via a duplexer 108 and an antenna.

A radio signal transmitted from the base station is received at the antenna, and output to a reception RF unit 109 via the duplexer 108. The received radio signal is converted into a base band digital signal by a reception RF unit 109 comprising a down-converter, an analog-digital converter, etc.

A fast Fourier transform (FFT) unit 110 executes fast Fourier transform of the base band digital signal and thereby divides the signal of the time area into signals of the frequency area, i.e. signals of the respective sub-carriers. The signals thus divided for the respective sub-carriers are output to a frequency channel separator 111.

The frequency channel separator 111 separates the signals divided for the respective sub-carriers into a pilot signal, a control channel signal and a data signal.

The pilot signal is descrambled by a pilot descrambling unit 112, in a descrambling pattern opposite to a scrambling pattern employed in the base station which transmits the signal to be received by the mobile station. The descrambling result is output to a control channel demodulator 114, a data channel demodulator 115 and a receiving signal quality measuring unit 113. On the basis of the pilot signal, the receiving signal quality measuring unit 113 measures the receiving signal quality of each resource block and also measures the channel variation amount. These measuring results are output to the CQI channel generator 103.

A control channel demodulator 114 processes the control channel signal output from the frequency channel separator 111, by channel equivalence using the pilot signal descrambled by the pilot descrambling unit 112 and then demodulates the signal. The control channel bit string thus demodulated is output to the controller 100.

The controller 100 controls all the units of the mobile station. On the basis of the information included in the control channel, the controller 100 discriminates whether or not the receive signal is a signal transmitted for the own mobile station, for each sub-frame. If the controller 100 discriminates that the receive signal is a signal transmitted for the own mobile station, the controller 100 extracts signaling information included in this signal, and detects information which is necessary for demodulation of the data channel signal and information which is necessary for decoding of the data channel signal, from the signaling information.

The information which is necessary for demodulation of the data channel signal is output to the data channel demodulator 115, while the information which is necessary for decoding of the data channel signal is output to the channel decoding unit 116. If the controller 100 discriminates that the receive signal is not a signal for the own mobile station, the demodulation or decoding of the data channel signal is terminated.

The data channel demodulator 115 processes each signal output from the frequency channel separator 111 by the channel equivalence using the pilot signal output from the pilot descrambling unit 112, and then demodulates the signal in the demodulation scheme designated by the controller 100, on the basis of the information output from the controller 100. The data bit string thus demodulated is decoded by the channel decoding unit 116, and the downlink data bit string for the own mobile station is thereby obtained. The information output from the controller 100 is used for the decoding.

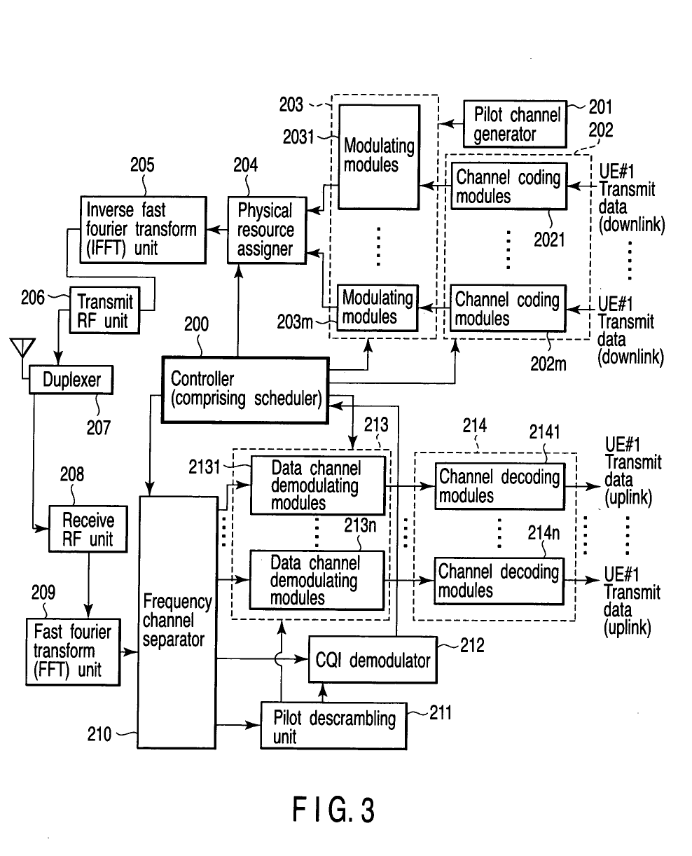

FIG. 3 shows a configuration of a transmitter (base station, i.e. Node B) of the radio communication system according to the embodiment of the present invention.

A pilot channel generator 201 generates a bit string which is the origin of a pilot signal transmitted over a pilot channel, processes the bit string with a scrambling code, and outputs the bit string to a modulator 203. A channel coding unit 202 comprises channel coding modules 2021 to 202m. Each of the channel coding modules 2021 to 202m processes a downlink transmission data bit string by channel coding at a channel coding rate designated by a controller 200 and outputs the bit string to the modulator 203.

The modulator 203 comprises modulating modules 2031 to 203m that correspond to the channel coding modules 2021 to 202m, respectively. Each of the modulating modules 2031 to 203m processes the bit strings which are original signals of the pilot signal and the channel-coded downlink transmit data signal, by digital modulation such as the quadrature phase shift keying (QPSK) in the modulation scheme designated by the controller 200, to generate the pilot signal and the transmit data signal.

The generated pilot signal and transmit data signal are assigned to the sub-carriers designated by the controller 200, by a physical resource assigner 204. To “assign the signals to the sub-carriers” means to add a sub-carrier index representing positions in a time axis and a frequency axis, of the sub-carriers in the corresponding resource block, to signals represented by complex numbers.

An inverse fast Fourier transform (IFFT) unit 205 converts a signal of the frequency area output from the physical resource assigner 204 into a signal of the time area, which is converted into a radio (RF) signal by a transmission RF unit 206 comprising a digital-analog converter, an up-converter, a power amplifier, etc. The RF signal is emitted into space, toward the base station, via a duplexer 207 and an antenna.

A radio signal transmitted from the mobile station is received at the antenna, and output to a reception RF unit 208 via the duplexer 207. The received radio signal is converted into a base band digital signal by a reception RF unit 208 comprising a down-converter, an analog-digital converter, etc.

A fast Fourier transform (FFT) unit 209 executes fast Fourier transform of the base band digital signal and thereby divides the signal of the time area into signals of the frequency area, i.e. signals of the respective sub-carriers. The signals thus divided for the respective sub-carriers are output to a frequency channel separator 210.

The frequency channel separator 210 separates the signals divided for the respective sub-carriers into a pilot signal, a control channel signal and a data signal.

The pilot signal is descrambled by a pilot descrambling unit 211, in a descrambling pattern opposite to a scrambling pattern employed in the mobile station which transmits the signal to be received by the base station. The descrambling result is output to a CQI demodulator 212 and a data channel demodulator 213.

The CQI demodulator 212 processes the CQI channel signal output from the frequency channel separator 210 by channel equivalence using the pilot signal descrambled by the pilot descrambling unit 211, and then demodulates the CQI channel signal. The CQI channel signal thus demodulated is further subjected to channel decoding by the CQI demodulator 212, and the CQI information transmitted from the mobile station is taken from the CQI channel signal and output to the controller 200.

The data channel demodulator 213 comprises a plurality of data channel demodulating modules 2131 to 213n. The data channel demodulating modules 2131 to 213n process the signals output from the frequency channel separator 210, respectively, by channel equivalence using the pilot signal output from the pilot descrambling unit 211, and then demodulate the signals in the demodulation scheme designated by the controller 200, on the basis of the information output from the controller 200. The data bit strings thus modulated are output to a channel decoding unit 214.

The channel decoding unit 214 comprises channel decoding modules 2141 to 214n which correspond to the data channel demodulating modules 2131 to 213n, respectively. The channel decoding units 2141 to 214n decode the data bit strings demodulated by the data channel demodulating modules 2131 to 213n, respectively, and obtain uplink data bit strings transmitted from the mobile station. The information output from the controller 200 is used for the decoding.

The controller 200 controls all the units of the mobile station. The controller 200 comprises scheduling means for controlling transmission of packers to the mobile stations for each frame, for example, on the basis of feedback information (Ack/Nack of reception response and CQI information), the data amount for each mobile station and the degree of priority. In accordance with the designation to the physical resource assigner 204, the controller 200 processes the data for a plurality of mobile stations by OFDM multiplexing in the same frame.

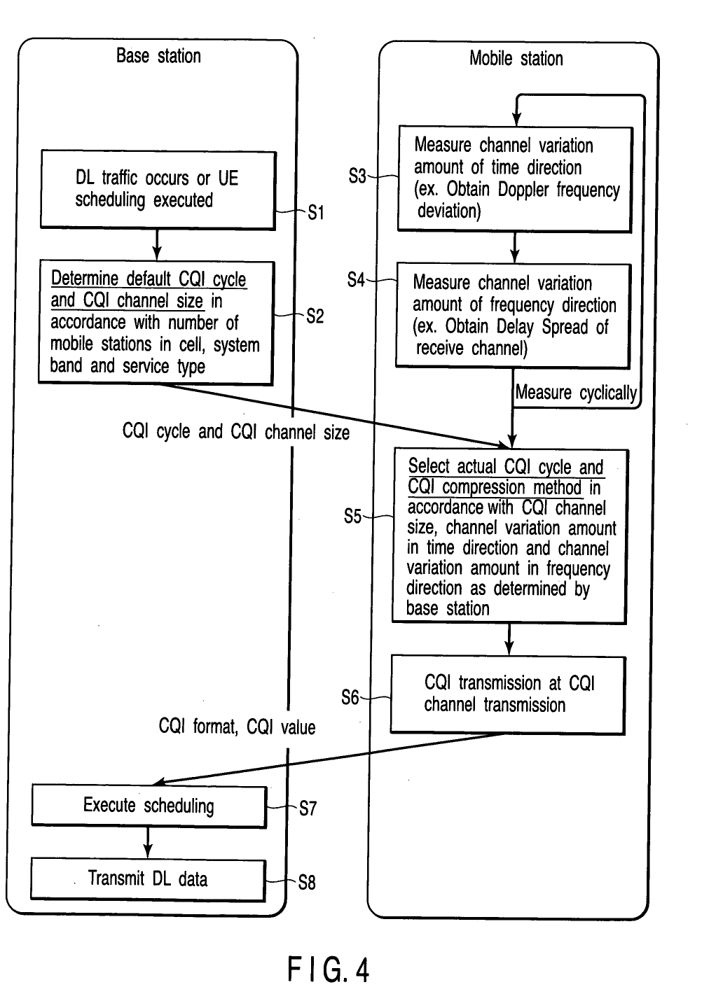

Next, operations of the radio communication system having the above configuration are described. Particularly, operations concerning the CQI transmission from the mobile station and the scheduling of the base station are focused. FIG. 4 illustrates a processing routing of the operations.

(Step S1) A downlink traffic occurs at the base station or the base station executes the mobile station scheduling in association with occurrence of the downlink traffic. At this time, the base station starts the assignment of the downlink resource blocks.

(Step S2) The base station determines the CQI updating cycle of the default for each mobile station and the CQI channel size, by considering the number of mobile stations located in the cell, the system band, the service type, etc. In general, when there are a number of mobile stations located in the cell, the base station (controller 200) widens the assignment cycle of the downlink resource and extends the CQI updating cycle in association with the assignment cycle. When the system band becomes wide, the downlink resource blocks which can be assigned are increased. In this case, the base station (controller 200) makes the CQI channel size greater.

The above service is roughly separated into three types (service types 1-3). since they are different in updating frequency and accuracy required for the CQI information, the CQI compression and the updating frequency need to be set in association with the updating frequency and accuracy.

Service type 1, low-speed communication, band preservation type (VoIP, etc.): Due to a low rate, the CQI information having a low resolution in the time direction and a low accuracy (and a proportionally small signaling overhead based on the CQI) is obtained by extending the CQI updating cycle.

Service type 2, high-speed communication, best effort type (HTTP, etc.): If the receiving signal quality is poor or the channel variation of the mobile station in the time direction is great, the CQI information having a low resolution in the time direction is obtained by extending the CQI updating cycle since the possibility of assigning the resource blocks is considered small. If the receiving signal quality is high and the channel variation of the mobile station in the time direction is small, the CQI information having a high resolution in the time direction is obtained by shortening the CQI updating cycle.

Service type 3, high-speed communication, band preservation type (Video Streaming, etc.): The CQI information having a high resolution in the time direction is obtained by shortening the CQI updating cycle.

In addition, the base station (controller 200) must determine the CQI updating cycle and the CQI channel size within the range which satisfies the lowest system quality. The base station notifies the mobile station side of the CQI updating cycle and the CQI channel size thus determined, under transmission control of the controller 200.

At the mobile station, processings of step S3 and step S4 are cyclically repeated until the mobile station receives the notification of step S2 from the base station. A certain period of time needs to be spent for the measurement of the channel variation amount. If the measurement is started after the notification of step S2 is received, an exact amount of channel variation cannot be obtained. A method of executing these processings after receiving the notification, at penalty in accuracy in the measured value of the channel variation amount in the initial CQI transmission, to reduce the power consumption, can also be employed.

(Step S3) The mobile station (controller 100) controls each units of the receiving system shown in FIG. 2 to measure the variation in the time direction, for each sub-carrier of the signal received from the base station. As the method of measuring the channel variation amount in the time direction, a method of measuring the channel variation amount by measuring the phase variation amount of the downlink pilot signal for a certain period of time, a method of obtaining the moving speed of the mobile station with the GPS, a method of measuring hand-off request frequency, etc. can be employed.

(Step S4) The mobile station (controller 100) controls each units of the receiving system shown in FIG. 2 to measure the variation in the frequency direction, for each sub-carrier of the signal received from the base station. As the method of measuring the channel variation amount in the frequency direction, a method of obtaining a reciprocal of multi-pass extension from a profile in the time domain of the reception channel, a method of measuring the phase variation amount of the downlink pilot signal for each certain frequency in the frequency domain, etc. can be employed.

When the mobile station (controller 100) receives the CQI updating cycle and the CQI channel size from the base station in step S2, the mobile station (controller 100) executes the following step S5.

(Step S5) The mobile station (controller 100) selects the actually applied CQI updating cycle and CQI compression method, on the basis of the CQI updating cycle and the CQI channel size transmitted from the base station, the channel variation in the time direction measured in step S3, and the channel variation in the frequency direction measured in step S4.

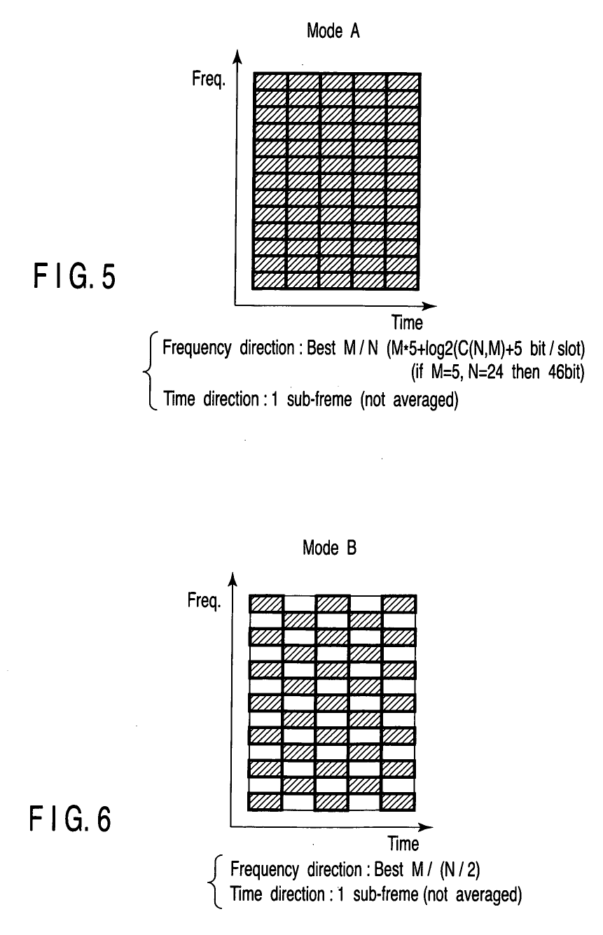

As the CQI compression method selected by the mobile station (controller 100) in step S5, four modes shown in FIG. 5 to FIG. 8 are prepared and one of them is arbitrarily selected. In each of the figures, the vertical axis indicates the frequency and the lateral axis indicates the time. A frame represents a resource block. The sub-frames for transmission of the CQI information, i.e. the sub-frames of the CQI updating cycle are aligned in the time direction.

First, in mode A (FIG. 5), number M of resource blocks with high CQI are obtained in all the resource blocks (number N) in the sub-frame of each CQI updating cycle. At this time, the necessary number of bits is expressed in the following formula (1). The first term represents the CQI values of number M of resource blocks, the second term represents a binary for representation of the positions of number M of resource blocks, and the last term represents an average of the CQI values of remaining resource blocks. The last term is necessary when the base station side executes the mobile station scheduling in response to the alienation rate from the average receiving signal quality, similarly to the proportional fairness.

M×(CQI bit number)+log₂(C_{M}^{N})+CQI bit number (1)

In Mode B (FIG. 6), the resource blocks in each sub-frame are separated into two groups (the group selected in each sub-frame is represented by hatching in FIG. 6), and number M of resource blocks having a high CQI are obtained from (number N/2) of selected groups, in each sub-frame of the CQI updating cycle. At this time, by alternately changing two groups in every CQI updating cycle, number 2M of upper CQI values can be consequently obtained from all the resource blocks in two CQI assignment cycles, at the mobile station. At each CQI measuring time, the receiving accuracy of the CQI measurement value can be enhanced by extending the average time in the time direction (to two CQI assignment cycle at maximum in this case).

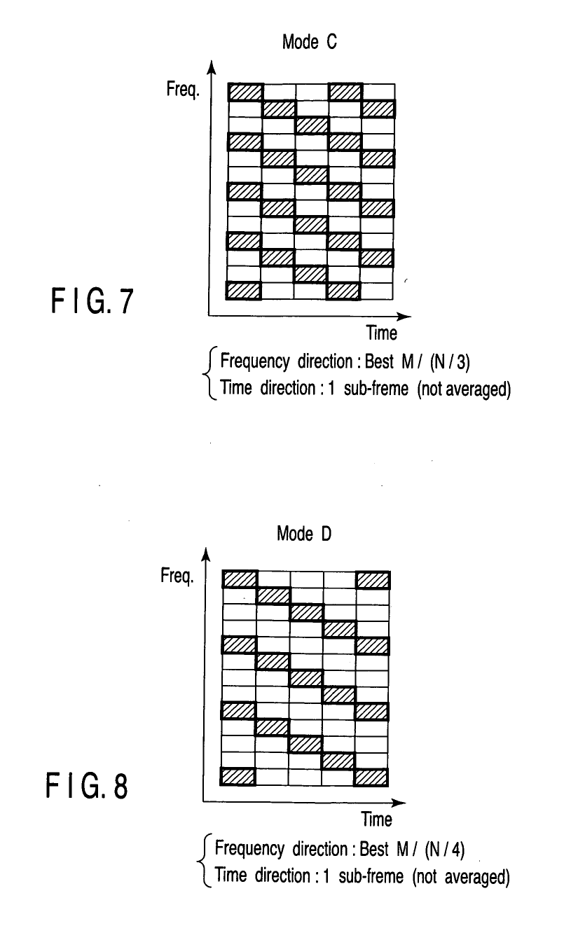

In Mode C (FIG. 7), the resource blocks of each sub-frame are separated to three groups (the group selected in each sub-frame is represented by hatching in FIG. 7). According to the Mode C, number 3M of upper CQI values can be consequently obtained from all the resource blocks in three CQI assignment cycles. Similarly, in Mode D (FIG. 8), the resource blocks of each sub-frame are separated to four groups (the group selected in each sub-frame is represented by hatching in FIG. 8). According to the Mode D, number 4M of upper CQI values can be consequently obtained from all the resource blocks in four CQI assignment cycles.

In these four Modes A-D, the number of CQI bits transmitted in each CQI updating cycle is substantially equal. However, an optimum mode of maximizing the downlink throughput is different in accordance with the ratio of the channel variation in the frequency direction to the channel variation in the time direction.

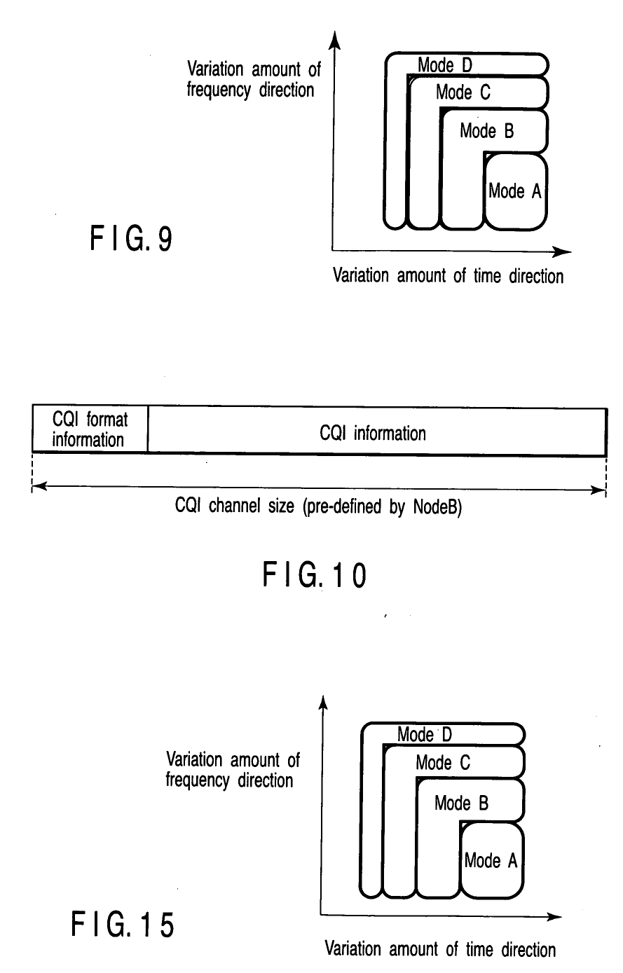

Selection of any one of these modes by the mobile station (controller 100) depends on cases shown in, for example, FIG. 9. For example, if the channel variation amount in the time direction is great and the channel variation amount in the frequency direction is small, the mobile station (controller 100) selects the Mode A. This is because the Mode A finds the resource blocks having a high CQI of all the resource blocks and the base station can execute downlink resource scheduling without delay. If the Mode D is selected in this environment, the base station refers to the CQI value before four CQI assignment cycles to refer to the CQI values of all the resource blocks, and brings about the receiving signal quality degradation resulting from the great value of the channel variation amount in the time direction.

Oppositely, the Mode D is advantageous in a case where the channel variation amount in the frequency direction is great and the channel variation amount in the time direction is small. The mobile station (controller 100) therefore selects the Mode D. If the Mode A is selected in this environment, the base station can obtain only number M of CQI values of all the resource blocks. Therefore, the degree of freedom of the scheduling is decreased, and the receiving performance is inferior to a case where the Mode D is selected.

In addition, the mobile station (controller 100) adjusts the CQI channel size by using the variable M of the above formula (1) as a parameter, to determine the actual CQI channel size in accordance with the CQI channel size which the base station notifies the mobile station. In this example, since there are four modes as the CQI compressing method, 2 bits are assigned to the CQI format information and the signals (CQI information) transmitted through a CQI channel shown in FIG. 10 are generated.

(Step S6) The mobile station (controller 100) controls all the units of the transmitting system shown in FIG. 2, urges the CQI channel generator 103 to generate the CQI information, and transmits the CQI information to the base station in the CQI updating cycle of which the mobile station (controller 100) is notified in step S2.

(Step S7) The base station (controller 200) controls all the units of the receiving system shown in FIG. 3, and receives the signal (CQI information) transmitted from the mobile station over the CQI channel in step S6. On the basis of the received CQI format information, the base station (controller 200) analyzes how to compress the CQI value transmitted from the mobile station, updates the CQI value of each resource block in the manner corresponding to the compression mode, and executes scheduling on the basis of the CQI value. In other words, the base station (controller 200) discriminates which resource block should be assigned to each mobile station, controls the physical resource assigner 204 on the basis of a result of the discrimination and assigns the physical resources.

(Step S8) The mobile station (controller 200) controls all the units of the transmitting system shown in FIG. 3, and transmits the transmit data (downlink) to the mobile station through the physical resources assigned in step S7.

In the radio communication system having the above-described configuration, the mobile station measures the channel variation in the time direction and the channel variation in the frequency direction, and selects the CQI compression method to be actually applied, on the basis of the channel variation in the frequency direction, the channel variation in the time direction, the CQI channel size and the CQI updating cycle which are transmitted from the base station. On the basis of the CQI format information, the base station analyzes in which compression mode the CQI value is compressed, and executes scheduling on the basis of the analysis result.

Therefore, since the mobile station can detect the channel variation and the moving speed more exactly than the base station, the mobile station can make the delay of the CQI information smaller and execute high-quality signal transmission by transmitting the CQI value in the CQI format selected on the basis of the detection result. In addition, since the mobile station side determines the CQI format and transmits the only information of the CQI format to the base station side, the signaling overhead caused by the communication concerning the CQI compression method between the mobile station and the base station can be made smaller.

In step S5, if the receiving signal quality at the mobile station side is lowered below the threshold value or the channel variation is adequately small and the mobile station (controller 100) therefore discriminates that the receiving signal quality can be maintained without updating the CQI, the mobile station may notify the base station that the CQI transmission is cancelled in a plurality of next and following CQI transmission cycles and may not execute the CQI transmission. On the basis of this notification, the base station may not receive the canceled CQI channel. If the CQI transmission is thus canceled, the base station can assign the cancelled radio resources to the other communications and, therefore, wasted signaling overhead can be decreased.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

For example, in the above embodiment, four modes shown in FIG. 5 to FIG. 8 are described as the CQI compression methods, but the methods are not limited to these four modes. Three or less of these modes may be combined, any one of these modes and other CQI compression methods may be selected, or a plurality of CQI compression methods other than those shown in FIG. 5 to FIG. 8 may be selectively employed.

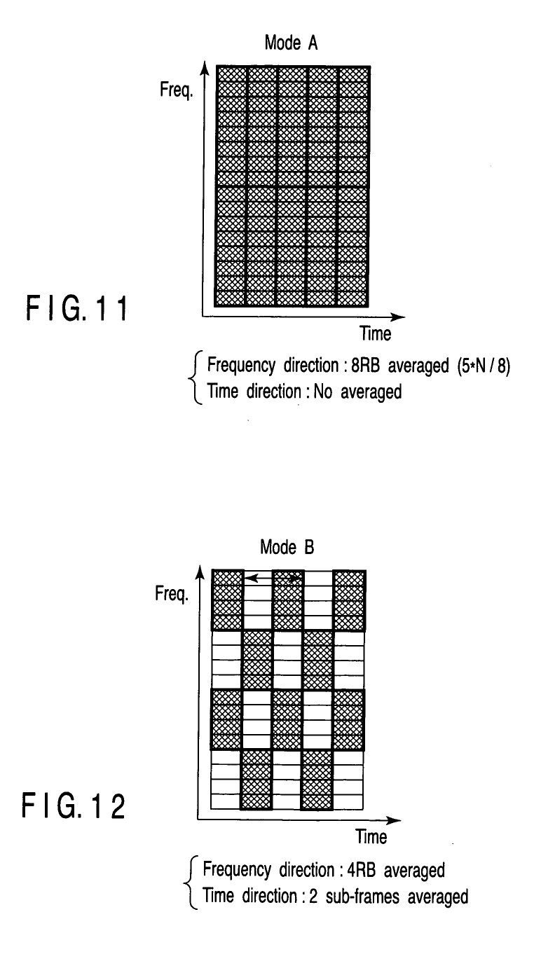

The CQI compression methods other than the CQI compression methods shown in FIG. 5 to FIG. 8 are shown in FIG. 11 to FIG. 14. Even if these CQI compression methods are employed, they can be executed in the processing routing shown in FIG. 4 employed in the above embodiment. The CQI compression methods shown in FIG. 11 to FIG. 14 have a plurality of averaging sections in the frequency direction and the time direction.

In Mode A shown in FIG. 11, the CQI channel generator 103 averages CQI values of eight resource blocks successive in the frequency direction in the sub-frames of each CQI updating cycle in accordance with the designation of the controller 100. The controller 100 controls all the units to transmit the averaged value to the base station in each CQI updating cycle.

In Mode B shown in FIG. 12, in accordance with the designation of the controller 100, the CQI channel generator 103 separates all the resource blocks in each sub-frame into two groups (the group selected in each sub-frame is represented by hatching in FIG. 12), averages CQI values of four resource blocks at the same timing successive in the frequency direction, and further averages the above two averaging results successive in the time direction. The controller 100 controls all the units to transmit the averaged value to the base station in each CQI updating cycle. In addition, in accordance with the designation of the controller 100, the CQI channel generator 103 can update the CQI values of all the resource blocks in two CQI assignment cycles by alternately changing two groups.

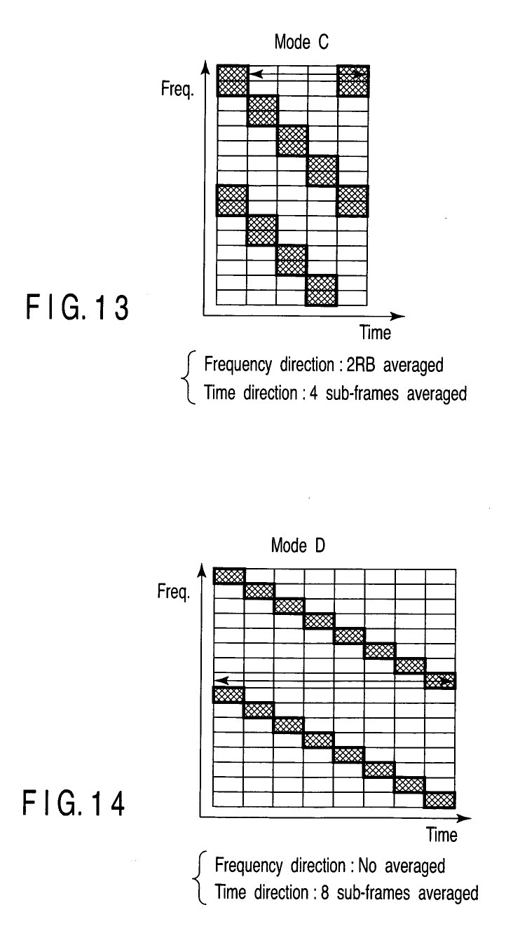

In Mode C shown in FIG. 13, in accordance with the designation of the controller 100, the CQI channel generator 103 separates all the resource blocks in each sub-frame into four groups (the group selected in each sub-frame is represented by hatching in FIG. 13), averages CQI values of two resource blocks at the same timing successive in the frequency direction, and further averages the above four averaging results successive in the time direction. The controller 100 controls all the units to transmit the averaged value to the base station in each CQI updating cycle. In addition, in accordance with the designation of the controller 100, the CQI channel generator 103 can update the CQI values of all the resource blocks in four CQI assignment cycles by sequentially changing four groups.

In Mode D shown in FIG. 14, in accordance with the designation of the controller 100, the CQI channel generator 103 separates all the resource blocks in each sub-frame into eight groups (the group selected in each sub-frame is represented by hatching in FIG. 14), averages eight CQI values successive in the time direction. The controller 100 controls all the units to transmit the averaged value to the base station in each CQI updating cycle. In addition, in accordance with the designation of the controller 100, the CQI channel generator 103 can update the CQI values of all the resource blocks in eight CQI assignment cycles by sequentially changing eight groups.

In these four modes, the number of CQI bits transmitted in each CQI updating cycle is equal. However, an optimum mode of maximizing the downlink throughput is different in accordance with the ratio of the channel variation in the frequency direction to the channel variation in the time direction. For this reason, the controller 100 selects the maximum mode under the conditions shown in FIG. 15.

For example, if the channel variation amount in the time direction is great and the channel variation amount in the frequency direction is small, the controller 100 selects the Mode A. This is because the Mode A finds the resource blocks having a high CQI of all the resource blocks and the base station can execute downlink resource scheduling without delay. At this time, since the channel variation amount in the frequency direction is small, a dropout of the information caused by averaging the CQI of the resource blocks in the frequency direction is small. If the Mode D is selected in this environment, the base station refers to the CQI value before eight CQI assignment cycles to refer to the CQI values of all the resource blocks, and brings about the receiving signal quality degradation resulting from the great value of the channel variation amount in the time direction.

Oppositely, the Mode D is advantageous in a case where the channel variation amount in the frequency direction is great and the channel variation amount in the time direction is small. The mobile station (controller 100) therefore selects the Mode D. If the Mode A is selected in this environment, the channel variation amount in the frequency direction is great. Thus, a dropout of the information caused by averaging the CQI of the resource blocks in the frequency direction is great, and the receiving performance is inferior to a case where the Mode D is selected.

Needless to say, the present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio apparatus, notifying a radio station of a channel quality and executing radio communication with the radio station under adaptive control of the radio station based on the channel quality, comprising:
a first measurement unit measuring variations of a plurality of channels utilized in the communication with the radio station;
a second measurement unit measuring receiving qualities of a plurality of channels utilized in the communication with the radio station;
a compressor generating quality information of compressing a result of the measurement of the second measurement unit, in a manner corresponding to a result of the measurement of the first measurement unit; and
a transmitter transmitting to the radio station the quality information generated by the compressor and compression manner information representing the manner employed by the compressor.

2. The apparatus according to claim 1, further comprising a receiver receiving size information from the radio station,
wherein the compressor compresses the measurement result of the second measurement unit, in a manner in which an information amount including the compression manner information and the quality information generated by the compressor becomes equal to an information amount represented by the size information.

3. The apparatus according to claim 1, wherein the first measurement unit measures variations in a frequency direction, of the plurality of channels utilized in the communication with the radio station.

4. The apparatus according to claim 1, wherein the first measurement unit measures variations in a time direction, of the plurality of channels utilized in the communication with the radio station.

5. The apparatus according to claim 1, wherein if at least one of the measurement result of the first measurement unit and the measurement result of the second measurement unit satisfies preset conditions, the transmission means transmits to the radio station information indicating that the transmitter does not transmit the quality information and the compression manner information.

6. A radio communication system wherein a first radio station notifies a second radio station of a channel quality, the second radio station executes adaptive control based on the channel quality, and under this control the first radio station executes a radio communication with the second radio station,
the first radio station comprising:
a first measurement unit measuring variations of a plurality of channels utilized in the communication with the second radio station;
a second measurement unit measuring receiving qualities of a plurality of channels utilized in the communication with the second radio station;
a compressor generating quality information of compressing a result of the measurement of the second measurement unit, in a manner corresponding to a result of the measurement of the first measurement unit; and
a transmitter transmitting to the second radio station the quality information generated by the compressor and compression manner information representing the manner employed by the compressor,
the second radio station comprising:
a receiver receiving the quality information and the compression manner information transmitted from the transmitter;
an analyzer analyzing in what compression manner the quality information is compressed, in accordance with the compression manner information received by the receiver; and
an assigner assigning channels to the first radio station in accordance with a result of the analysis of the analyzer.

7. The system according to claim 6, wherein the first radio station further comprises receiver receiving size information from the radio station; and
the compressor compresses the measurement result of the second measurement unit, in a manner in which an information amount including the quality information generated by the compressor and the compressing manner information becomes equal to an information amount represented by the size information.

8. The apparatus according to claim 6, wherein the first measurement unit measures variations in a frequency direction, of the plurality of channels utilized in the communication with the radio station.

9. The system according to claim 6, wherein the first measurement unit measures variations in a time direction, of the plurality of channels utilized in the communication with the radio station.

10. The system according to claim 6, wherein if at least one of the measurement result of the first measurement unit and the measurement result of the second measurement unit satisfies preset conditions, the transmitter transmits to the radio station information indicating that the transmitter does not transmit the quality information and the compression manner information.

11. A radio communication method wherein a first radio station notifies a second radio station of a channel quality, the second radio station executes adaptive control based on the channel quality, and under this control the first radio station executes a radio communication with the second radio station,
the first radio station comprising:
first measurement of measuring variations of a plurality of channels utilized in the communication with the second radio station;
second measurement of measuring receiving qualities of a plurality of channels utilized in the communication with the second radio station;
compressing a measurement result of the second measurement, in a manner corresponding to a measurement result of the first measurement; and
transmitting to the second radio station the quality information generated by the compressing and compression manner information representing the manner employed by the compressing,
the second radio station comprising:
receiving the quality information and the compression manner information transmitted from the transmitting;
analyzing in what compression manner the quality information is compressed, in accordance with the compression manner information received by the receiving; and
assigning channels to the first radio station in accordance with an analysis result of the analyzing.

12. The method according to claim 11, wherein the first radio station further comprises receiving size information from the radio station; and
the compressing compresses the measurement result of the second measurement, in a manner in which an information amount including the quality information generated by the compressing and the compressing manner information becomes equal to an information amount represented by the size information.

13. The method according to claim 11, wherein the first measurement measures variations in a frequency direction, of the plurality of channels utilized in the communication with the radio station.

14. The method according to claim 11, wherein the first measurement measures variations in a time direction, of the plurality of channels utilized in the communication with the radio station.

15. The method according to claim 11, wherein if at least one of the measurement result of the first measurement and the measurement result of the second measurement satisfies preset conditions, information indicating that the quality information and the compression manner information are not transmitted is transmitted to the radio station.
